(19) United States
(12) Patent Application Publication
(10) Pub. No.: US 2004/0223522 A1
(43) Pub. Date: Nov. 11, 2004

(54) Producing a polarized laser beam with minimum divergence and a desired spatial cross-section

(76) Inventor: F. William Hersman, Durham, NH (US)

Correspondence Address: Devine, Millimet & Branch, P.A., 111 Amherst Street, Manchester, NH, 03101, US

(21) Appl. No.: 10/772,836

(22) Filed: Feb. 5, 2004

Related U.S. Application Data
(60) Provisional application No. 60/445,310, filed on Feb. 5, 2003.

(51) Int. Cl. H01S 3/30

(52) U.S. Cl. 372/6

(57) ABSTRACT

A system for polarizing laser light produces a polarized laser beam with a desired spatial cross-section and minimum divergence. Optical fibers emitting laser light are configured to a chosen spatial cross-section. The emitted laser light is split into two beams that are polarized. The spatial cross-section of one of the beams are combined so that they are aligned and contiguous.

### CROSS-REFERENCE TO RELATED APPLICATIONS

The present application claims the benefit of provisional patent application Ser. No. 60/445,310 filed Feb. 5, 2003, which is incorporated herein by reference.

### TECHNICAL FIELD

The present invention relates to polarizing laser light and, more particularly, to a method and apparatus for producing a polarized laser beam with minimum divergence and a desired spatial cross-section.

### BACKGROUND INFORMATION

Many modern applications require high power polarized laser beams. These beams are often produced by an array of laser diodes. As an example, polarized laser beams can be used to polarize material in a polarizing cell by illuminating the polarizing cell. As a further example, alkali atom vapor can be polarized in a polarizing cell through the use of high power circularly polarized laser beams.

Existing optical systems used to produce a polarized laser beam use a beam splitter cube to split an initial laser beam into components of linear polarization. The linearly polarized components are then converted to circularly polarized beams by passing them through quarter wave plates oriented at a plus or minus 45° from the axis of the plane of linear polarization. The circularly polarized laser beams are then combined. The geometry of the combined laser beams is such that they diverge from the point of combination at an angle Ø. As Ø is decreased to minimize divergence, the spatial concentration of the combined polarized beams at the point of combination decreases and the spatial cross-section of the combined beams at the point of combination may not be desirable.

Accordingly, there is a need for a system to produce a polarized laser beam with minimum divergence and a desired spatial cross-section, thereby increasing the optical power that can be delivered for various applications, including the illumination of polarizing cells.

### SUMMARY

The present invention is a method and apparatus for producing a polarized laser beam with minimum divergence and a desired spatial cross-section, comprising primarily two steps. First, optical fibers transmitting laser light are configured with a spatial cross-section so that the shape of the spatial cross-section is one-half of the shape of the desired spatial cross-section. Second, optical elements are arranged to split the laser light emitted by the optical fibers into two component beams, to polarize identically the component beams, to focus the component beams at a common intermediate focal point, to invert the spatial cross-section of one of the component beams before it reaches the common focal point, and to combine the component beams so that they are aligned and contiguous at or near the common focal point, thereby producing a polarized laser beam with the desired spatial cross-section and minimum divergence.

### BRIEF DESCRIPTION OF THE DRAWINGS

These and other features and advantages of the present invention will be better understood by reading the following detailed description, taken together with the drawings wherein:

FIG. 1A is a schematic diagram of an existing optical system for producing a polarized laser beam.

FIG. 1B is a diagram of a cross-section of the intersection at the limiting case of two polarized laser beams according to an existing optical system for producing a polarized laser beam.

FIG. 2A is a diagram of a spatial cross-section of optical fibers configured according to one embodiment of the present invention.

FIG. 2B is a diagram of a spatial cross section of a laser beam emitted by optical fibers configured, and a polarized laser beam produced, according to one embodiment of the present invention.

FIG. 3 is a schematic diagram of an arrangement of optical elements according to one embodiment of the present invention.

FIG. 4 is a schematic diagram of an optical system for an exemplary application of a polarized laser beam produced by an embodiment of the present invention.

### DETAILED DESCRIPTION OF THE PREFERRED EMBODIMENTS

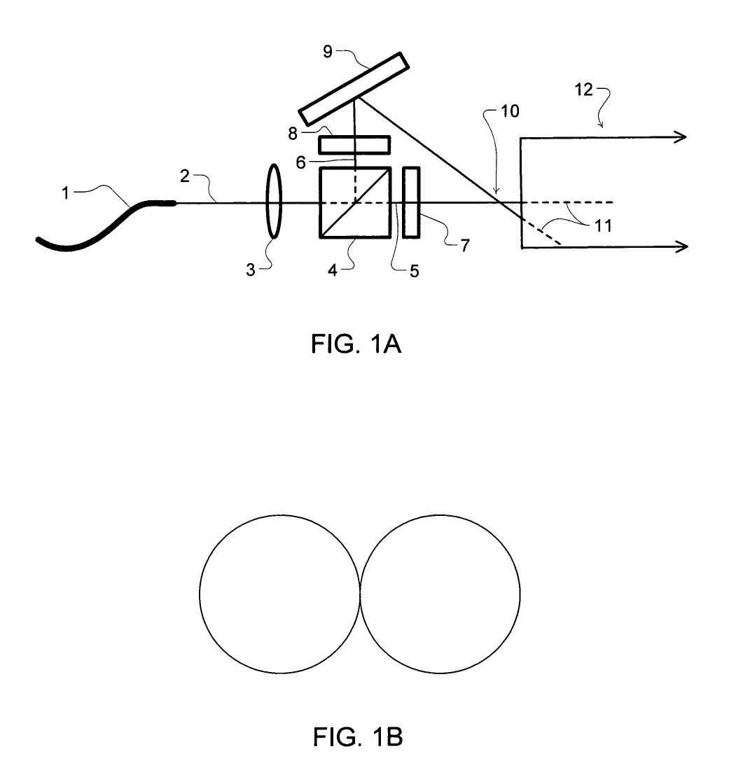

The present invention is a method and apparatus for producing a polarized laser beam with minimum divergence and a desired spatial cross-section. Existing systems for producing polarized laser beams typically employ a minimal arrangement of optical elements, as shown in FIG. 1A. Laser light is transmitted from one or more fiber-coupled lasers to the optical elements through a plurality of optical fibers 1 usually arranged for convenience to have a circular spatial cross-section. A laser beam 2 emerges from the optical fibers into the air and is collimated by a convex lens 3. The laser beam then passes through a beam-splitter polarizing cube 4 that separates the beam, by reflecting part of it, into a first component beam 5 and a second component beam 6, which beams are perpendicularly polarized. The linearly polarized component beams are then converted to circularly polarized component beams by passing then through quarter wave plates 7, 8 at a plus or minus 45° from the axis of the plane of linear polarization. This arrangement produces two component beams that are identically circularly polarized. Finally, the second component beam 6 is reflected by a mirror 9 through an angle greater than 90° to merge with the first component beam 5 at a point 10.

If the spatial cross-section of the optical fibers is circular, the geometry of the intersecting component beams 5, 6 at point 10 is that of two intersecting cylinders. However the component, beams 5, 6 diverge from point 10 at an angle Ø 11 determined by the geometry of the arrangement of optical elements. The drawback of this and similar polarizing systems is the divergence of the component beams. As is also shown in FIG. 1A, one modern application of polarized laser beams is to illuminate a long cylindrical polarizing cell 12 containing subject matter to be polarized. Only the first component beam 5 along the axis of the polarizing cell 12 illuminates the entire cell. The second component beam 6 does not, decreasing the optical power delivered to the polarizing cell 12. There is an additional drawback to this system when it is used to polarize alkali atom vapor. Both component beams 5, 6 are not be along the axis of the magnetic field, which is along the axis of the polarizing cell. The component beam 6 not along the axis of the magnetic field is referred to as “skew light” and drives the alkali polarization to a state that is not fully transparent.

It should be noted that the geometry of the optical system shown in FIG. 1A can be changed to decrease angle Ø 11 and the divergence of the component beams 5, 6. However, as angle Ø 11 decreases, the spatial cross-section of the intersecting component beams changes. As angle Ø 11 approaches zero, the geometry of the intersecting component beams 5, 6, as shown in FIG. 1B, decreases in spatial concentration and changes shape to approach tangential circles.

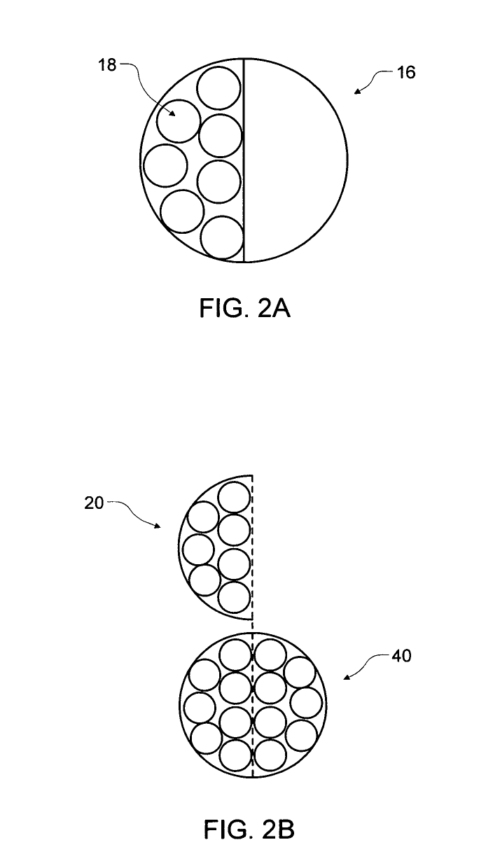

The present invention to produce a polarized laser beam comprises primarily configuring optical fibers transmitting laser light and arranging optical elements, both as described in detail below. The optical fibers are configured so that a spatial cross-section of the fibers is a shape that is one-half of the shape of the desired spatial cross-section. For example, in one embodiment as shown in FIG. 2A, if the spatial cross-section desired for the polarized laser beam is a circle 16, the optical fibers are configured to create a semi-circular spatial cross-section 18. As the number of optical fibers involved increases, it becomes easier to achieve the desired configuration, which can be accomplished through the use of any one of a number of physical means known to one of ordinary skill in the art, including metal or plastics forms of the desired spatial cross-section. In the limiting case of a small number of optical fibers, they cannot be realistically configured to produce a spatial cross-section of a particular shape.

The optical elements are arranged, as described in detail below for one embodiment, to achieve among other ends, splitting the laser beam emitted by the optical fibers into two component beams, inverting the spatial cross-section of one of the component beams, and combining the two component beams to form a laser beam with the desired cross-section. For example, as shown in FIG. 2B, a laser beam from the optical fibers 20 arranged with a semi-circular spatial cross-section is split into two component beams. One of the component beams is inverted, and the two component beams are then combined to form a laser beam with a circular cross-section 40. Again, in the limiting case of such a small number of optical fibers that they cannot be configured to form a spatial cross-section of a particular shape, there is no need to invert one of the component beams.

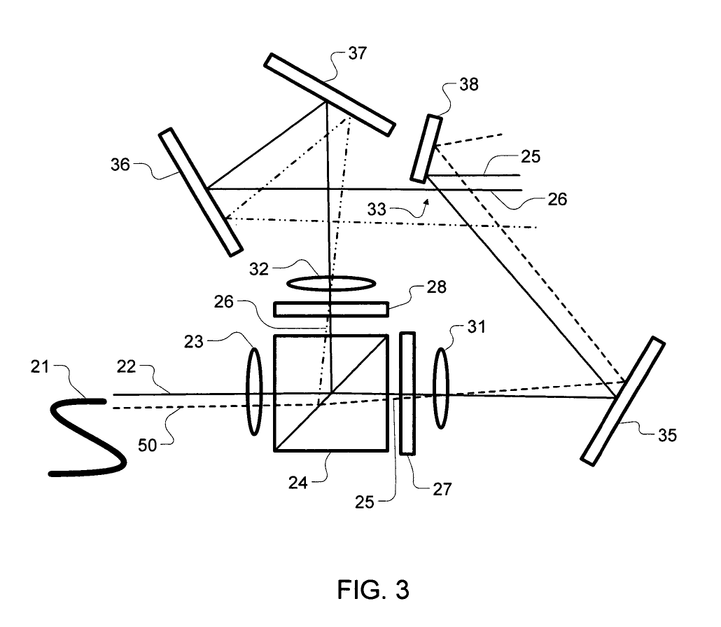

In one preferred embodiment of the present invention, the optical fibers are configured, as described above, to have a semi-circular spatial cross-section 20. The optical elements are then configured as shown in FIG. 3. A laser beam 22 emerges from the configured optical fibers 21 into the air and is collimated by a convex lens 23. Then, as in an existing system, the laser beam passes through a beam splitter polarizing cube 24 that separates the beam, by reflecting part of it, into a first component beam 25 and a second component beam 26, which beams are perpendicularly polarized. The first component beam 25 then passes through a quarter wave plate 27, and the second component beam 26 passes through a quarter wave plate 28. The quarter wave plates 25, 26 are each positioned with the fast axis either + or −45° relative to the vertical so as to achieve the desired direction of circular polarization. In other embodiments, the beams may be identically lineally polarized through the use of approximate optical components known to hose of ordinary skill in the art.

In this embodiment, a first converging lens 31 and a second converging lens 32 are each placed in the path of one of the component beams. The converging lens 31, 32 have common focal lengths chosen to produce a magnified image of the spatial cross-section of the optical fibers at an intermediate focal point 33. The first component beam 25 is reflected once by mirror 35 before reaching the focal point 33. The second component beam 26 is reflected three times, once by polarizing cube 24 and once each by mirror 36 and mirror 37, before reaching the focal point 33. In an alternative embodiment, instead of introducing two converging lens 31, 32, the component beams may be brought to an intermediate focal point by adjusting the distance between the optical fibers 21 and the convex lens 23. In another embodiment, the number of times that the first component beam 25 is reflected and the number of times that the second component beam 25 is reflected may be changed. In an embodiment in which the spatial cross-section of one of the component beams is to be inverted, the number of times each component beam is reflected may be changed so long as the difference between the number of times the first component beam is reflected and number of times the second component beam is reflected is a positive or negative odd integer.

At or near the focal point 33, a mirror 38 is placed to reflect the first component beam 25 so that it is aligned with the second component beam 26. This produces a combined first component beam 25 and second component beam 26 with a minimum divergence. The mirror 38 is also placed so that the reflected first component beam 25 is contiguous or nearly contiguous to the second component beam 26. Because the arrangement of the optical elements has caused the spatial cross-section of the first component beam 25 to be inverted as compared to the spatial cross-section of the second component beam 26, the combined first component beam 25 and second component beam 26 then have a desired polarized laser beam cross-section, as shown in FIG. 2B, that is circular 40. It should be noted that FIG. 3 shows an off-axis ray of laser beam 22. As laser beam 22 and its component beams 25, 26 traverse the optical elements comprising the embodiment shown in FIG. 3, the off-axis ray shows whether a particular spatial cross-section of laser beam 22, or of one of its component beams 25, 26 is inverted or not.

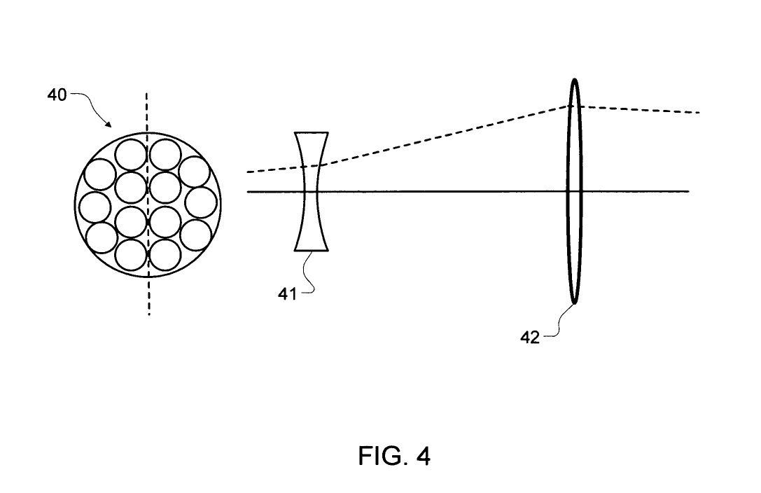

At this point, the combined polarized laser beam with a circular cross-section is diverging from a focus. A further arrangement of optical elements can be used, as shown in FIG. 4, to optimize the combined beam 40 for a specific application. For example, a diverging lens 41 may be used to spread the beam before a converging lens 42 collimates it.

In this embodiment of the present invention, deflection of the first and second component beams is accomplished primarily by using mirrors. In other embodiments, deflection of a component beam can be accomplished with one of a variety of optical elements such as prisms, diffraction gratings, and other appropriate optical elements known to those of ordinary skill in the art. Moreover, in this embodiment, the spacial cross-sections of the first and second beams were inverted by reflecting the beams with mirrors. In other embodiments, inversion of a component beam can be accomplished with one of a variety of optical elements such as a convex lens or other appropriate optical elements known to those of ordinary skill in the art. In still other embodiments, as described above, the number of optical fibers may be so small that they cannot be realistically configured to produce a spatial cross-section of a particular shape. In those embodiments, inversion of a component beam is unnecessary

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

The Invention claimed is:

1. A method for producing a polarized laser beam with minimum divergence and a desired spatial cross-section, comprising:
emitting a laser beam from optical fibers;
configuring the optical fibers with a spatial cross-section in a shape that is one-half the shape of the desired cross-section;
splitting the laser beam emitted from the configured optical fibers into a first component beam with a spatial cross-section and a second components beam with a spatial cross-section;
circularly polarizing the first and second component beams;
focusing the first and second component beams at a focal point;
inverting the spatial cross-section of one of the component beams compared to the spatial cross-section of the other component beam; and
combining the first and second component beams at or near the focal point so that they are aligned and contiguous or nearly contiguous.

2. A system for producing a polarized laser beam with minimum divergence and a desired spatial cross-section, comprising:
optical fibers emitting a laser beam configured with a spatial cross-section in a shape that is one-half the shape of the desired cross-section;
means for splitting the laser beam emitted from the configured optical fibers into a first component beam with a spatial cross-section and a second component beam with a spatial cross-section;
means for circularly polarizing the first and second component beams;
means for focusing the first and second component beams at a focal point;
means for inverting the spatial cross-section of one of the component beams compared to the spatial cross-section of the other component beam; and
means for combining the first and second component beams at or near the focal point so that they are aligned and contiguous or nearly contiguous.

3. The system of claim 2 wherein the means for splitting the laser beam comprises a beam-splitter polarizing cube.

4. The system of claim 2 wherein the means for polarizing the first and second component beams comprises two quarter wave plates, positioned with a fast axis of either +45° or −45° relative to the vertical so an to achieve the desired direction of circular polarization.

5. The system of claim 2 wherein the means for focusing the first and second component beams are two converging lenses with common focal lengths.

6. The system of claim 2 wherein the means for inverting the spatial cross-section of one of the component beams compared to the spatial cross-section of the other component beam is a mirror.

7. The system of claim 2 wherein the means for combining the first and second component beams is a mirror.

8. The system of claim 2 wherein the means for combining the first and second component beams is a prism.

9. A system for producing a polarized laser beam with minimum divergence and a desired spatial cross-section, comprising:
optical fibers emitting a laser beam configured with a spatial cross-section that is one-half the desired cross-section;
a polarizing cube for splitting the laser beam into a first component beam and a second component beam;
two quarter wave plates positioned with a fast axis of +45° or −45° relative to the vertical so as to achieve the desired direction of circular polarization;
a first converging lens for focusing the first component beam at a focal point and a second converging lens with a common focal length with the first converging lens for focusing the second component beam of at the focal point;
a mirror for inverting the spatial cross-section of one of the component beams compared to the spatial cross-section of the other component beam; and
a mirror for combining the first and second component beams at or near the focal point so that they are aligned and contiguous or nearly contiguous.

10. A system for producing a polarized laser beam with minimum divergence and a desired spatial cross-section, comprising:
optical fibers emitting a laser beam configured with a spatial cross-section in a shape that is one-half the shape of the desired cross-section;
means for splitting the laser beam emitted from the configured optical fibers into a first component beam with a spatial cross-section and a second component beam with a spatial cross-section;
means for linearly polarizing in the same plane the first and second component beams;
means for focusing the first and second component beams at a focal point;
means for inverting the spatial cross-section of one of the component beams compared to the spatial cross-section of the other component beam; and
means for combining the first and second component beams at or near the focal point so that they are aligned and contiguous or nearly contiguous.

11. A method for producing a polarized laser beam with minimum divergence, comprising:
emitting a laser beam from optical fibers;
splitting the laser beam emitted from the configured optical fibers into a first component beam with a spatial cross-section and a second components beam with a spatial cross-section;
circularly polarizing the first and second component beams;
focusing the first and second component beams at a focal point; and
combining the first and second component beams at or near the focal point so that they are aligned and contiguous or nearly contiguous.

12. A system for producing a polarized laser beam with minimum divergence, comprising:
optical fibers emitting a laser beam;
means for splitting the laser beam emitted from the configured optical fibers into a first component beam with a spatial cross-section and a second component beam with a spatial cross-section;
means for circularly polarizing the first and second component beams;
means for focusing the first and second component beams at a focal point; and
means for combining the first and second component beams at or near the focal point so that they are aligned and contiguous or nearly contiguous.
